(19) United States
(12) Patent Application Publication
(10) Pub. No.: US 2013/0346091 A1
(43) Pub. Date: Dec. 26, 2013

(54) TRANSITION MONITORING AND STATISTICAL ANALYSIS

(71) Applicant: Kenneth Margon, Selangor (MY)

(72) Inventor: Kenneth Margon, Selangor (MY)

(21) Appl. No.: 13/839,346

(22) Filed: Mar. 15, 2013

Related U.S. Application Data
(63) Continuation-in-part of application No. 13/247,999, filed on Sep. 28, 2011.
Application No. 13/247,999 is a continuation-in-part of application No. 13/214,156, filed on Aug. 19, 2011.
Application No. 13/214,156 is a continuation-in-part of application No. 12/712,488, filed on Feb. 25, 2010.
(60) Provisional application No. 61/155,510, filed on Feb. 25, 2009.
(60) Provisional application No. 61/179,605, filed on May 19, 2009.

(51) Int. Cl. G06F 19/00

(52) U.S. Cl. CPC G06F 19/3418
USPC 705/2

(57) ABSTRACT

The present invention provides, in at least one embodiment, a device, system, and method for remote healthcare. A personal health server device is connected to one or more wired or wireless medical devices. The medical devices monitor medical data such as heart rate, body weight, oxygen saturation, medical adherence, blood coagulation, blood pressure, glucose, temperature, or activity level. The personal health server device stores the medical data from the medical devices and wirelessly transmits the medical data to web enabled browsers through a cellular carrier using a cellular carrier signal such as 3G, 4G, or LTE, with no need for an internet connection.

### CROSS-REFERENCE TO RELATED APPLICATIONS

This application is a continuation-in-part and claims the benefit of U.S. patent application Ser. No. 13/247,999 entitled “WIRELESS PHYSIOLOGY MONITOR” filed Sep. 28, 2011, which is a continuation-in-part and claims the benefit of U.S. patent application Ser. No. 13/214,156 entitled “PHYSIOLOGICAL DATA ACQUISITION UTILIZING VIBRATIONAL IDENTIFICATION” filed Aug. 19, 2011, which is a continuation-in-part and claims the benefit of U.S. patent application Ser. No. 12/712,488 entitled “WIRELESS PHYSIOLOGY MONITOR” filed Feb. 25, 2010, which claims priority under 35 U.S.C. § 119(e) to U.S. Provisional Patent Application No. 61/155,510, entitled “WIFI OFDM MODULATED CARRIER FOR HEART AND LUNG MONITORING” filed Feb. 25, 2009, and U.S. Provisional Patent Application No. 61/179,605, entitled “FALL DETECTION AND HEART/LUNG MONITORING” filed May 19, 2009. The disclosures of the above-noted applications are incorporated by reference herein in their entirety.

### BACKGROUND OF THE INVENTION

1. Field of Invention

The invention relates generally to remote healthcare, and more particularly, to techniques for providing remote healthcare through cellular carrier signals.

2. Description of Related Art

Health care is often delivered in places outside of hospitals and health care facilities. These places include community care programs, self-care, home care, long term care, assisted living, and substance abuse centers. Community care programs include needle exchange programs and other distributions to prevent the transmission of diseases.

Self-care is any activity of an individual, family, or community, with the intention of improving or restoring health, or treating diseases. Self-care includes all health decisions people as individuals or consumers make for themselves and their families to get and stay physically and mentally fit.

Home care, also referred to as domiciliary care, social care, home health care, formal care, etc., is health care provided in the patient's home by a healthcare professional. Often, the term home care is different from non-medical care or custodial care, which is care that is provided by persons who are not nurses, doctors, or other licensed medical personnel, as opposed to home health care that is provided by licensed personnel.

Long-term care is a variety of services which help meet both the medical and non-medical needs of people with a chronic illness or disability who cannot care for themselves for long periods of time.

Assisted living residences provide supervision and assistance with activities of daily living, coordination of services by outside health care providers, and monitoring of resident activities to help to ensure their health, safety, and well-being. Assisted living residences may include the administration or supervision of medication or personal care services provided by a trained staff person.

In computer electronics, a server is a physical computer dedicated to running one or more services to serve the needs of users of the other computers on a network. Examples of servers include: a database server, a file server, a mail server, a print server, a web server, an application server, a catalog server, a communication server, a fax server, a game server, a home server, a name server, a proxy server, a sound server, a standalone server, etc.

In the context of Internet Protocol (IP) networking, a server is a program that operates as a socket listener. In the context of client-server architecture, a server is a computer program to serve the requests of other programs known as clients. Thus, the server performs some computational task on behalf of its clients. The clients either run on the same computer or connect through the network.

Servers often provide essential services across a network, either to private users inside a large organization or to public users via the Internet. For example, when a person enters a query in a search engine, the query is sent from their computer over the Internet to the servers that store all the relevant web pages. The results are sent back by the server to their computer. Virtually every action taken by an ordinary Internet user requires one or more interactions with one or more servers.

Efficient, effective, and reliable remote healthcare monitoring is a considered the holy grail in medicine. However, effective solutions have so far proved elusive. One conventional remote healthcare solution, E-Care, developed a monitoring system to capture, transmit, and distribute vital health data to doctors, caregivers, and family. E-Care monitors patients with chronic or long-term illnesses such as diabetes or cardiovascular disease, and patients discharged after an operation or serious medical crises, such as stroke victims.

E-Care's remote monitoring system includes a wireless intelligent sensor network (WISE), bio-medical sensors, and a radio terminal WISE consists of a series of monitors that track signs like activity, temperature, pulse, blood pressure, and glucose or other personal data like weight, pain measurement, and drug conformance. Data collected by the sensors are sent to the transmitter that sends them to the central system. The central system includes a medical data manager (MDM) that automatically checks patient data against the patient's record and any doctor's notes. If there is a disturbing change in the patient's vital signs, for example high glucose levels in a diabetic, an alarm is sent directly to the patient's physician. The E-Care repository stores all patient data.

However, conventional remote healthcare systems fall short, because they lack a device that is truly simple to set up and simple to transfer data to a medical professional and others without an internet connection.

### SUMMARY OF THE INVENTION

The present invention overcomes these and other deficiencies of the prior art by providing a device, system, and method for a personal health server device connected to one or more wired or wireless medical devices. The medical devices monitor medical data such as heart rate, body weight, oxygen saturation, medical adherence, blood coagulation, blood pressure, glucose, temperature, or activity level. The personal health server device stores the medical data from the medical devices and wirelessly transmits the medical data to web enabled browsers through a cellular carrier using a cellular carrier signal such as 3G, 4G, or Long Term Evolution (LTE).

In one embodiment of the invention, a device comprises: a receiver configured to connect to a medical device configured to obtain medical data; a storage connected to the receiver, wherein the storage is configured to store the medical data from the medical device; and a transmitter connected to the storage, wherein the transmitter is configured to transmit wirelessly the medical data to a web enabled browser through a cellular carrier using a cellular carrier signal. The cellular carrier signal may comprise 3G, 4G, or LTE. The medical device may comprises a heart rate monitor, a body weight scale, an oxygen saturation monitor, a medical adherence monitor, a blood coagulation monitor, a blood pressure monitor, a glucose monitor, a temperature monitor, or an activity level monitor. The web enabled browser may comprise a smartphone or a personal computer. The smartphone may comprise an app configured to display the medical data. The device may further comprise a backup battery. The medical device may comprise a wireless medical device.

In another embodiment of the invention, a method comprises the steps of: connecting to a medical device configured to obtain medical data; storing the medical data from the medical device; and transmitting wirelessly the medical data to a web enabled browser through a cellular carrier using a cellular carrier signal. The cellular carrier signal may comprise 3G, 4G, or LTE. The medical device may comprise a heart rate monitor, a body weight scale, an oxygen saturation monitor, a medical adherence monitor, a blood coagulation monitor, a blood pressure monitor, a glucose monitor, a temperature monitor, or an activity level monitor. The web enabled browser may comprise a smartphone or a personal computer. The smartphone may comprise an app configured to display the medical data. The cellular carrier may connect to an app. The method may further comprise using a backup battery. The medical device may comprise a wireless medical device.

In a further embodiment of the invention, a system comprises: a medical device configured to obtain medical data; a receiver connected to the medical device and configured to receive the medical data; a storage connected to the receiver, wherein the storage is configured to store the medical data; and a transmitter connected to the storage, wherein the transmitter is configured to transmit wirelessly the medical data to a web enabled browser through a cellular carrier using a cellular carrier signal. The cellular carrier signal may comprise 3G, 4G, or LTE. The medical device may comprise a heart rate monitor, a body weight scale, an oxygen saturation monitor, a medical adherence monitor, a blood coagulation monitor, a blood pressure monitor, a glucose monitor, a temperature monitor, or an activity level monitor. The web enabled browser may comprise a smartphone or a personal computer, where the smartphone may comprise an app configured to display the medical data. The system may further comprise an apps store comprising medical apps.

In another embodiment of the invention, a method implemented entirely on a processor comprises the steps of: receiving signals from a plurality of motion sensors, wherein the signals indicate movement of a living subject, each of the plurality of motion sensors located in a different physical area of interest, determining a number of transitions of the living subject from a first physical area of interest to a second physical area of interest over a given period of time, and recording the determined number of identified transitions of the living subject from the first physical area of interest to the second physical area of interest. The different physical area of interest is selected from the group consisting of: a bedroom, a living room, stairs, a balcony, a garden, a kitchen, a toilet or bathroom, and a combination thereof. The method may further comprise the step of displaying the determined number of identified transitions of the living subject from the first physical area of interest to the second physical area of interest. The method may further comprise determining a number of transitions of the living subject from a third physical area of interest to a fourth physical area of interest over the given period of time, and recording the determined number of identified transitions. The method may further comprise the step of analyzing the determined number of identified transitions of the living subject from the first physical area of interest to the second physical area of interest against a predetermined norm, and calculating a deviation of the determined number of identified transitions of the living subject from the first physical area of interest to the second physical area of interest from the predetermined norm. The method may further comprise generating an alert when the deviation exceeds a predetermined threshold.

An advantage of the present invention is that it is simple and cost effective to deploy. The personal health server device is not tethered by cables or a phone line. The medical devices are seamlessly paired with the personal health server device by wireless connections such as Bluetooth, WiFi, or ZigBee, allowing pairing without user intervention. The personal health server device is preconfigured with configuration data pertaining to each medical device. Non-wireless medical devices like infusion pumps and oxygen concentrators can also be connected to the personal health server device through wired connections such as a universal serial bus (USB), a subscriber identity module (SIM) card, or a serial port connection.

Additionally, the personal health server device provides increased data access. The personal health server device provides continuous monitoring of the medical devices as the personal health server device is always on. To allow the personal health server device to always be recording medical data, a battery backup can be provided for power outages. The medical data can be viewed by any web enabled device.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, and the advantages thereof, reference is now made to the ensuing descriptions taken in connection with the accompanying drawings briefly described as follows:

FIG. 1 illustrates a remote health care system according to an embodiment of the invention;

FIGS. 2-4 illustrate the system according to embodiments of the invention;

FIG. 5 illustrates hardware for a personal health server device of the system according to an embodiment of the invention;

FIG. 6 illustrates apps on a smartphone according to an embodiment of the invention;

FIG. 7 illustrates a process of transmitting medical data through a cellular carrier signal according to an embodiment of the invention; and

FIG. 8 illustrates a transitions log according to an embodiment of the invention.

### DETAILED DESCRIPTION OF EMBODIMENTS

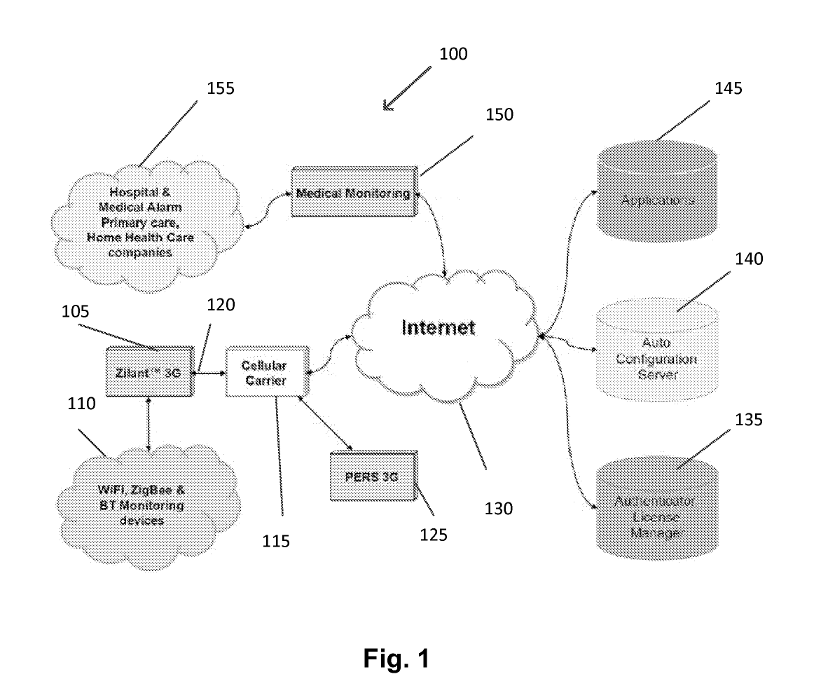

Further features and advantages of the invention, as well as the structure and operation of various embodiments of the invention, are described in detail below with reference to the accompanying FIGS. 1-8, wherein like reference numerals refer to like elements. Although the invention is described in the context of transmitting a user's medical data from his home to a doctor at a hospital, one of ordinary skill in the art appreciates that the device disclosed herein can transmit medical data from other places and to other people. The device can be located in a hospital, skilled nursing facility, assisted living setting, etc. The medical data can be provided to other professionals and non-professionals as well, such as, but not limited to, a nurse, a caregivers, a family member, and a trusted friend.

The present invention provides, among other things, a device, system, and method for remote healthcare. A personal health server device is connected to one or more wired or wireless medical devices, with no need for an internet connection. In one embodiment, the personal health server device and medical devices (e.g., a weight scale and a blood pressure monitor) are sent to user's home. The user or a nurse connects the personal health server device, and the medical devices (if necessary), to a power outlet. The personal health server device and medical devices automatically communicate with one another seamlessly without the user or the nurse's involvement via a local connection such as ZigBee, WiFi, or Bluetooth. The personal health server device communicates with the Internet via a cellular network connection such as 3G, 4G, or LTE. The personal health server device connects the user's medical devices with remote doctors and others, a centralized medical server, and/or remote applications running on family members' smartphones.

FIG. 1 illustrates a remote health care system 100 according to an embodiment of the invention. The system 100 includes a personal heath server device 105, one or more medical devices 110, a cellular carrier 115 having a cellular carrier signal 120, one or more personal web browsers 125, the Internet 130, a license authentication manager 135, a central server 140, an apps store 145, one or more hospital web browsers 150, and a hospital 155.

The system 100 provides an improved remote health care and home monitoring system through a cloud based computing and storage platform. The system 100 enables anytime-anywhere health monitoring and response to improve the user's quality of life. The system 100 has a receiver to receive medical data from the medical devices 110 and a transmitter to transmit the user's medical data to others using the cellular carrier signals 120. As such, the user is not limited to residing in places which have internet connection. The system 100 provides monitoring of medical data which allows the user to have independent living. Absent this monitoring, the user would normally be confined to a medical setting for observation of their medical data, such as a hospital, home care, long term care, assisted living, etc. Instead, the system 100 allows the user the option of independent living without being bogged down by wired medical devices, medical personnel, or only places with Internet access.

The device 105 (e.g., server, personal health server, Zilant server, etc.) receives medical data from the medical devices 110, and provides the medical data to others. The medical data can be viewed remotely by a primary care physician, a caregiver, a family member, and others through any web enabled device such as a personal computer (PC), tablet, or smartphone. The device 105 includes a storage for storing the medical data. The storage can be a solid state or fixed hard drive storage.

The device 105 can also have a backup battery for power outages such that the device 105 can always remain on and record medical data. The device 105 can have or be a structured query language (SQL) server. SQL is a programming language designed for managing data in relational database management systems. The device 105 is designed with network server functionality, such that this saves the user the cost having to install an external server.

The device 105 need not be tethered by cables or phone lines enabling cost effective deployment. Further, the device 105, once the power cord is plugged in, automatically begins pairing with the medical devices 110 through a wireless (e.g., Bluetooth, ZigBee, etc.) connection. ZigBee is a high level communication protocol using small, low-power digital radios for personal area networks. The ZigBee technology is intended to be simpler and less expensive than other wireless personal area networks (WPANs), such as Bluetooth.

The device 105 may also provide home security through motion sensors to monitor patient activity throughout the home. The motion sensors can provide home automation by controlling lights, doors, electrical appliances, detecting smoke, detecting carbon monoxide, etc.

The device 105 can support medical health record formats from the Institute of Electrical and Electronics Engineers (IEEE) and can convert legacy serial Bluetooth devices to the IEEE format. The medical data can be accessed and processed by machine to machine (M2M) devices through XML based protocols. M2M refers to technologies that allow both wireless and wired systems to communicate with other devices, such as a sensor or a meter that captures an event such as temperature or inventory level which is relayed through a system to an application that translates the captured event into meaningful information such as, items that need to be restocked.

Various medical devices 110 may monitor the user (e.g., person, patient, etc.) receiving remote healthcare. The medical devices 110 may include a blood pressure monitor, a body weight scale, a glucose monitor, an oxygen saturation monitor, a medical adherence monitor, a temperature monitor, an activity level monitor, a blood coagulation monitor, a heart rate monitor, an Electrocardiography (ECG), etc. ECG includes electrodes attached to the user's skin that monitor the electrical activity of the heart over time.

The medical devices 110 may also include a WiFi camera allowing for visual observations of critical users. The medical devices 110 may be for users living with diabetes, hypertension, Alzheimer's, dementia, heart disease including congestive heart failure (CHF), living alone and needing assurance, recovering from major surgery including coronary artery bypass graft (CABG), hip replacement, organ transplant, sleep disorders including sleep apnea, chronic obstructive pulmonary disease (COPD) including emphysema and asthma.

The medical devices 110 can be connected to the device 105 through wired or wireless technologies including local networks such as a wireless local area network (WLAN), a personal area network (PAN), a wireless sensor network (WSN), etc. These local networks include technologies such as WiFi, Bluetooth, ZigBee, USB, serial ports, SIMs, etc. The local networks provide intelligent wired and wireless connectivity to the medical devices 110 located throughout the user's home.

In general, WLAN links two or more devices using some wireless distribution method, typically spread-spectrum or orthogonal frequency-division multiplexing (OFDM) radio, and usually provides a connection through an access point to the wider internet. This gives users the mobility to move around within a local coverage area and still be connected to the network. Most modern WLANs are based on IEEE 802.11 standards, marketed under the WiFi brand name. In general, PAN is a computer network used for communication among computer devices, including telephones and personal digital assistants, in proximity to an individual's body. The reach of a PAN is typically a few meters. PANs may be wired with computer buses such as USB and FireWire. A wireless personal area network (WPAN) can also be made possible with wireless network technologies such as IrDA, Bluetooth, Wireless USB, Z-Wave and ZigBee. In general, WSN consists of spatially distributed autonomous sensors to monitor physical or environmental conditions, such as temperature, sound, vibration, pressure, motion, or pollutants and to cooperatively pass their data through the network to a main location. The more modern networks are bi-directional, also enabling control of sensor activity.

The cellular carrier 115 can be any carrier, such as AT&T, Sprint, T-Mobile, Verizon, etc. The cellular carrier 115 has a cellular carrier signal 120. The cellular carrier signal 120 can be a wide area network (WAN). A WAN is a telecommunication network that covers a broad area, such as a network that links across metropolitan, regional, or national boundaries. A WAN can be used to connect the device 105 to the cellular carrier 115 to the one or more personal web browsers 125 or the Internet 130. The Internet 130 can connect to the authentication license manager 135, the central server 140, the apps store 145, and to the hospital web browsers 150 of the hospital 155.

The cellular carrier signal 120 includes 3G, 4G, and LTE to connect the device 105 to the Internet 130 and personal web browsers 125. In general, 3G is the third generation mobile telecommunications standard for mobile phones and mobile telecommunication services with applications including wide-area wireless voice telephone, mobile Internet access, video calls and mobile TV. In telecommunications, 4G is the fourth generation of cellular wireless standards and is the successor to the 3G and 2G families of standards. In general, LTE, also known as 3GPP, is a standard for wireless communication of high-speed data for mobile phones and data terminals. LTE is based on the GSM/EDGE and UMTS/HSPA network technologies, increasing the capacity and speed using new modulation techniques.

The cellular carrier signal 120 and its medical data are secured and protected. This can be accomplished by multiple 3G and WiFi security levels and data encryptions which provide an additional security layer, four active firewalls, and http-based authentication. The network can be secured by a public key cryptography. Additionally, the network can be secured by a private key split between multiple nodes, where the device 105 keeps one part of the private key and the central server 140 provides another part of the private key.

The personal web browsers 125 include remote PCs, tablets, smartphones, etc. This means that the user viewing the screen or user interface of the personal web browser 125 can be located away from the device 105. The user can access the device through a web server as opposed to direct access to the device 105. The personal web browsers 125 allow personal users to view the user's medical data. The personal users include the user, the user's friends and family, the user's caregiver, nurse, etc.

The personal web browsers 125 promote a multi-generation approach to family health, where parents take care of kids and vice versa. By including family and friends, the system 100 is more effective than a system which relies solely on professional medical providers. The caregiver can be provided with an established protocol on what preventative or emergency actions should be taken for a given issue. Further, the user can self-manage and monitor their own health, with the assurances that others are providing daily supervision.

The personal web browsers 125 can view data with any monitor or browser using WiFi, 3G, or a local area network (LAN). A LAN is a computer network that interconnects computers in a limited area such as a home, school, computer laboratory, or office building. LAN's include high data transfer rates than wide area networks (WANs), cover a smaller geographic area, and do not need leased telecommunication lines.

The Internet 130 (e.g., cloud, internet cloud, etc.) is well known to one of ordinary skill in the art. The Internet 130 is a global system of interconnected computer networks that use the standard Internet protocol suite (TCP/IP) to serve billions of users worldwide.

The license authentication manager 135 manages the setup of the medical devices 110. The authentication license manager 135 maintains dynamic IP addresses as they change so that they can be accessed through the device 105.

The central server 140 (e.g., configuration server) is separate from the personal health server device 105. The central server 140 can store medical data and security keys for encryption of medical data.

The apps store 145 provides a database of smartphone, tablet, and PC apps along with other programs for the system 100. An app can be tied to a particular medical device 110, such that a user or his doctor downloads the apps corresponding to the user's particular medical situation. The apps store 145 can be signed up by a doctor or the user when the doctor prescribes a medical solution for the user. The apps are downloaded to the smartphone, tablet, or PC on the hospital web browser 150 and/or the personal web browser 125. The medical solution can include one or more apps. Each app can be tied to one or more devices. In one embodiment, the doctor downloads two apps for the user, and each app is tied to two separate medical devices 110. The doctors at the hospital 155 or the user's family using the personal web browsers 125 can monitor the patient's measurements or trends using a particular app.

The hospital web browsers 150 include remote PCs, tablets, and smartphones at the hospital 155. The hospital web browsers 150 allow for remote management by a primary care physician or other medical professional through the cellular carrier 115 and the Internet 130. Remote management is common in the telecommunications industry for remote configuration and management of network devices. The hospital web browser 150 also runs business logic from the device 105 allowing for two way communications between a doctor or nurse at the hospital 155 and the user or family member at the personal web browser 125. XML or cloud based business logic eases retrieval of medical data by medical service providers at the hospital 155.

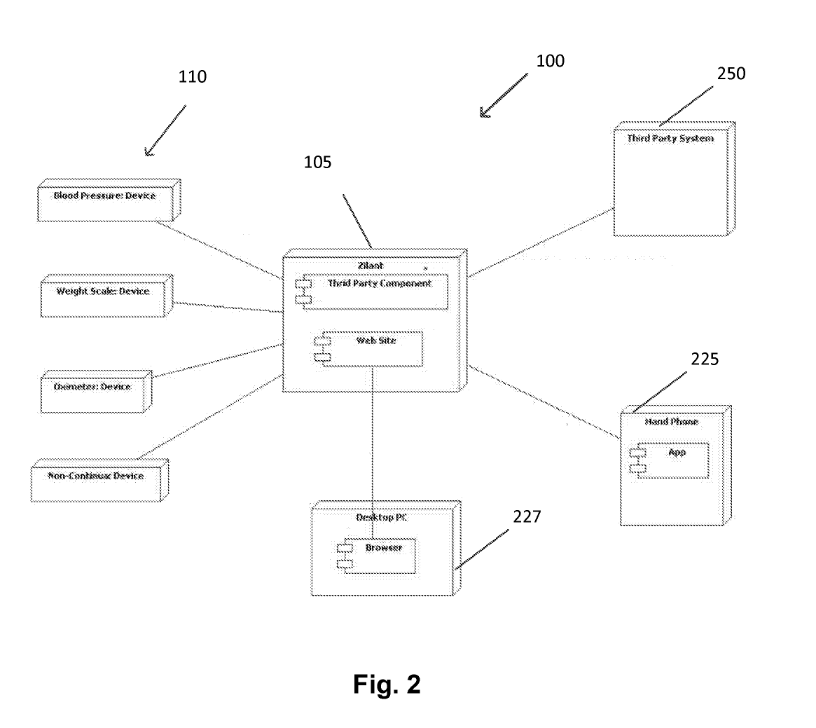

FIGS. 2-4 illustrate the system 100 according to embodiments of the invention. FIG. 2 illustrates the device 105 attached to the medical devices 110, a personal computer (PC) 227, a smartphone 225, and a hospital system 250. The device 105 contains website hardware that can connect to any web enabled device, including the smartphone 225 and the PC 227. The smartphone 225 can be connected to the device 105 by simple object access protocol (SOAP) or representational state transfer (REST). The PC 227 can be connected to the device 105 through the hypertext transfer protocol (HTTP).

The smartphone 225 can access the medical data using an access code. The smartphone 225 includes apps from the app store 145. The apps correspond to one or more of the medical devices 110. The illustrated medical devices 110 include a blood pressure device, a weight scale device, an oximeter device, and a non-continua device. The non-continua device can be connected using a serial port and the other medical devices can be connected using Bluetooth.

The device 105 includes third party component hardware to connect with the hospital system 250. The hospital system 250 can include the hospital web browsers 150 and the hospital 155. The hospital system 250 can be connected with the device 105 through REST, health level seven (HL7) with XML, SOAP, or JavaScript Object Notation (JSON).

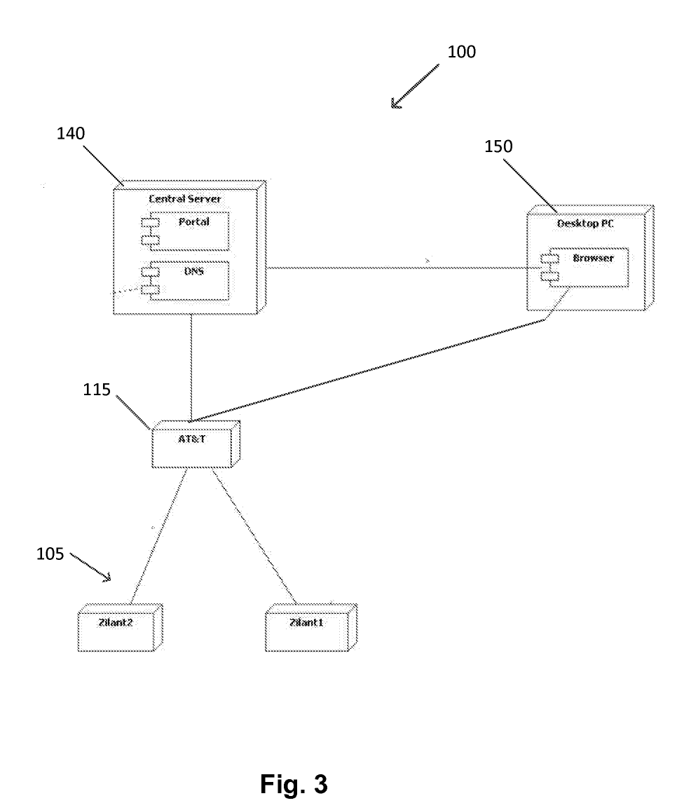

FIG. 3 illustrates a plurality of devices 105 and their connectivity between the nodes of the system 100. The devices 105 connect to the cellular carrier 115, such as AT&T, through the cellular carrier signal 120, such as 3G. The cellular carrier 115 connects to the central server 140 and the hospital web browser 150 through a virtual private network (VPN) such as the Internet 130 (not shown). VPN is a network that uses primarily public telecommunication infrastructure, such as the Internet, to provide remote offices or traveling users access to a central organizational network. The web browser 150 can be a desktop PC, laptop, tablet, or smartphone. The hospital web browser 150 can connect to the central server 140 and the cellular carrier 115 through the Internet 130.

Each device 105 can be assigned a unique dynamic public IP address. The public IP address is mapped to a domain name in the domain name server (DNS). The mapping is updated upon changing the IP address. The medical professional using the hospital web browser 150 can access a particular user's device 105 using an Internet website domain name corresponding to the user's dynamic public IP address.

Alternatively, each device 105 can be assigned a private IP address. A network address translation (NAT) within the cellular carrier 115 can perform port forwarding to a particular device 105. NAT is the process of modifying IP address information in IP packet headers while in transit across a traffic routing device.

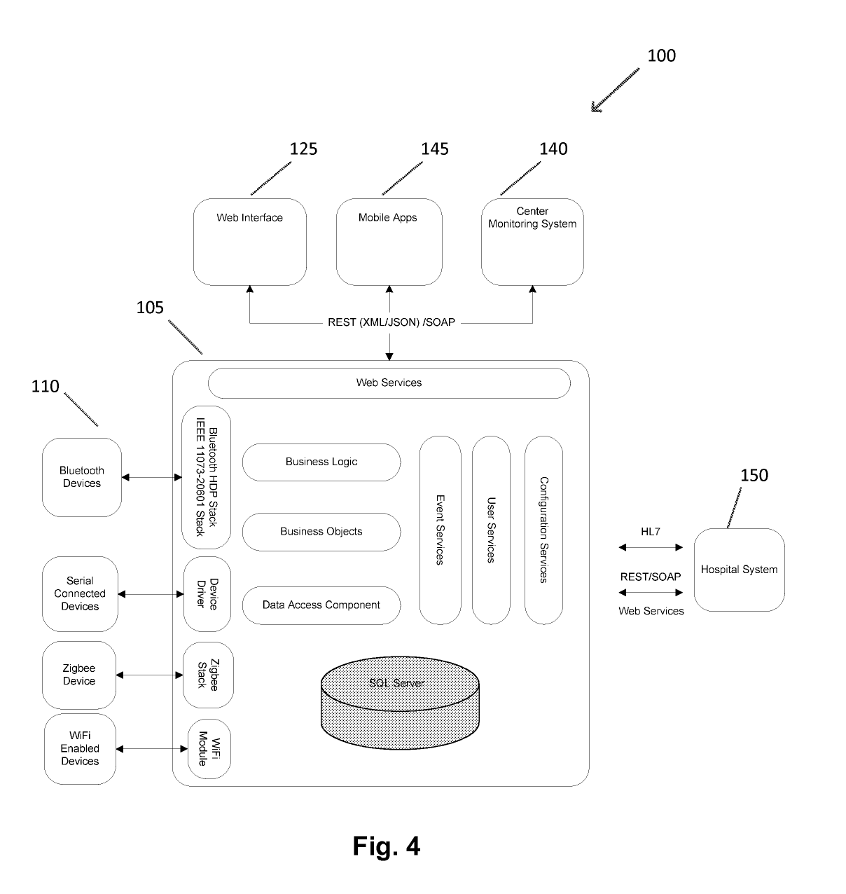

FIG. 4 illustrates the application architecture for the device 105 of the system 100. The web services of the device 105 connect to the personal web browsers 125, the app store 145, the central server 140, and the hospital web browsers 150. The medical devices 110 include Bluetooth devices attached to a Bluetooth stack, serial connected devices connected to a device driver, ZigBee devices connected to a ZigBee stack, and WiFi enabled devices connected to a WiFi module. The device 105 includes configuration services, user services, event services, business logic, business objects, a data access component, and a SQL server to receive, store, process, and transmit medical data. SQL is also embedded in the firmware.

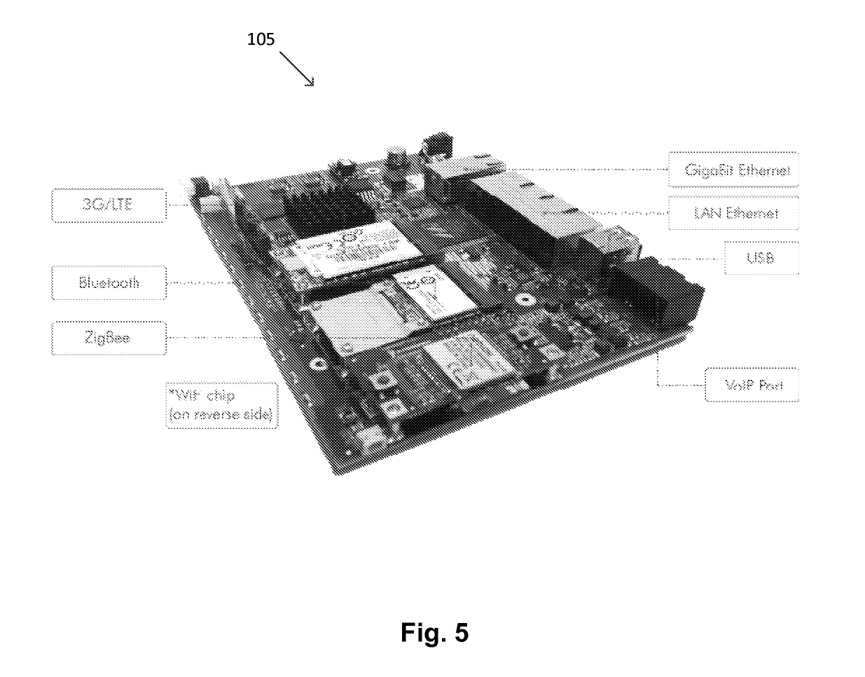

FIG. 5 illustrates hardware for the device 105 of the system 100 according to an embodiment of the invention. The device 105 includes cellular carrier signal hardware such as 3G or LTE, local network hardware such as Bluetooth, ZigBee, WiFi, GigaBit Ethernet, LAN Ethernet, USB, and a VoIP port, the implementation of which is known by one with ordinary skill in the art.

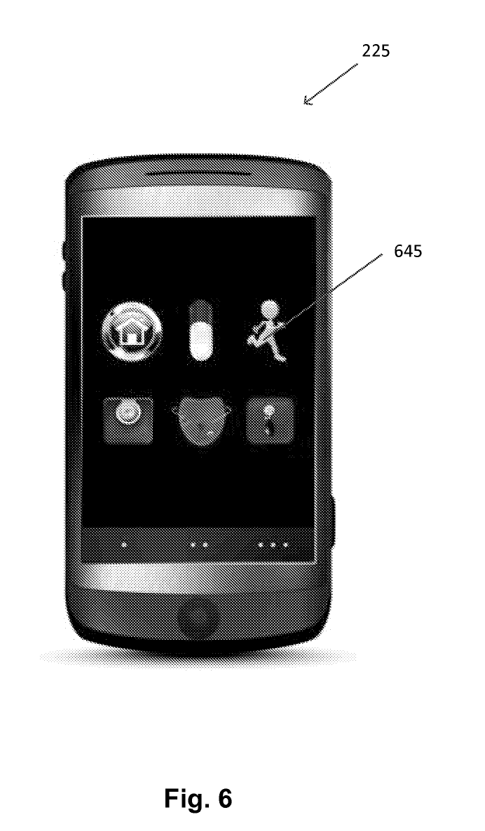

FIG. 6 illustrates apps 645 on the smartphone 225 according to an embodiment of the invention. The apps 645 (e.g., medical apps, mobile apps, tablet apps, etc.) allow the user and his friends, family, and others to access the device 105 and the data from the medical devices 110. The apps 645 provide real time information critical to assisting the user whether or not they are near the medical devices 110. The apps 645 provide a peace of mind for the elderly and their family. The apps 645 increase compliance and effectiveness of the remote medical care and reduce emergencies.

The illustrated apps 645 include a safe at home app, a missed medication app, a low activity app, a rapid weight gain app, a heart and respiration app, and a blood pressure app. The safe at home app indicates whether the user arrived home safely. The missed medication app indicates whether the user missed taking their medication. The low activity app indicates if the user has dropped their activity below a threshold. The rapid weight gain app indicates if the user has gained weight too quickly. The heart and respiration app indicates if the levels are too high or low for the user's activity level. It is critical to monitor respiratory rates as an indicator of a user's health status. Abnormal respiratory rates and changes in respiratory rate are a broad indicator of major physiological instability, and in many cases, respiratory rate is one of the earliest indicators of this instability. The blood pressure app indicates if the user's blood pressure is too high or low.

The system 100 provides additional benefits. The 3G, WiFi, ZigBee, and Bluetooth capabilities allow the system 100 to be easily upgraded later with unique and future applications. Further, accountable care organizations (ACO) can gain substantial savings as the users can reduce visits to the emergency department. The system 100 produces a better quality of care at lower cost. The system 100 promotes preventative care and allows caregivers to more effectively track and treat their patients. The detailed user medical data is recorded by minutes, hours, days, weeks, and months allowing caregivers to identify either specific events or trends and proactively modify medications and treatment plan.

The system 100 allows the users to easily become active participants in the health care process and play an active, informed role to self-manage their illness and maintain compliance with prescriptions. The system 100 can provide automated reminders such that users keep track of prescriptions and appointments. A daily health status is updated and wirelessly communicated in real time, so family members, users, and caregivers can immediately identify variations from normal and provide immediate feedback. The family members are updated on the user's health status by web access even when the family is away on vacation. This flexibility prevents excessive travel, intrusive medical visits and hospitalizations, and promotes a sense of independence. The monitoring can be tailored to provide individualized treatment to specific needs.

The device 105 always maintains a session with a cellular network. This means that the device 105 can be contacted through the cellular network through an Internet protocol (IP) address at any time. The screen viewed by the personal web browser 125 is decoupled from the device 105. Any browser enabled device can access through WiFi or through the Internet cloud. This makes the screen like a peripheral. A peripheral is a device attached to a host computer, but not part of it, and is more or less dependent on the computer. Examples include computer printers, image scanners, tape drives, microphones, loudspeakers, webcams, and digital cameras.

The IP address can be dynamic, meaning not fixed. The authentication license manager 135 maintains these dynamic IP addresses as they change so that they can be accessed through the device 105.

Different web pages can be served to different users through different usernames and password. The web server runs java script and hypertext preprocessor (PHP) so that applications are actually running on the web page and also logic is pushed out to the browser. PHP is an HTML-embedded scripting language with much of its syntax borrowed from C, Java, and Perl, with the goal to allow web developers to write dynamically generated pages quickly. The peripherals supported and their drivers are in the firmware.

The web server has access to the various facilities in the device 105 including the output of the peripherals. The logic to control and interact with the peripherals is compiled in firmware. This decouples the operation of the peripherals from the web based application to ensure stability and support the protocols used by each device 105. This allows the device 105 to have an open architecture on the web side but also allows us to interface with a number of peripherals without them having to adhere to standards.

The device 105 can use technical report 069 (TR-069). TR-069 is a telecom protocol broadband forum defining an application layer protocol for remote management of end-user devices. The device's TR-069 technology can update the firmware and deploy updates across all the devices 105 on a network, or individual devices 105. TR-069 is used to manage and update the device 105 remotely. TR-069 telecom technology is ideal for mass updating of firmware.

Configuration and registration (pairing) of new devices can be done remotely. Further, firmware updates, new web pages, pretty good privacy (PGP) or common gateway interface (CGI) can be deployed remotely. PGP is a data encryption and decryption computer program that provides cryptographic privacy and authentication for data communication. CGI is a standard method for web server software to delegate the generation of web pages to executable files.

All the data from the sensors are stored in the device 105 and can be accessed by any applications (browser based) in parallel. Multiple applications can also manipulate sensors or peripherals. The device 105 integrates Bluetooth, WiFi, and ZigBee sensors into one system 100 which can all be utilized and manipulated by browser based applications. The various medical devices 110 are not required to follow a standard. The medical data is combined into an electronic health record.

The system 100 uses closed architecture on the peripheral side and uses open architecture on the application and browser side. A split private key is used to open access to a particular user. After the authentication server sends half the private key to the device 105, the device 105 concatenates that half of the private key with the device's half of the private key. The authentication server sends the public key to the browser. Preferably, hypertext transfer protocol secure (HTTPS) is used. HTTPS is a combination of the hypertext transfer protocol (HTTP) with transport layer security (TLS), and its predecessor, secure sockets layer (SSL), protocol to provide encrypted communication and secure identification of a network web server.

The private apps store 145 allows the health care provider to choose an application to the specific disease being managed. This application is downloaded into the smartphone 225. This application is browser based, such as extensible markup language (XML) and health level seven (HL7). XML a set of rules for encoding documents in machine-readable form. HL7 is an organization that develops international healthcare informatics interoperability standards. HL7 also refers to the organization's standards. HL7 provides a framework and standards for the exchange, integration, sharing, and retrieval of electronic health information. XML including an HL7 client can still be used to by the health care provider to get data into a health care information system or electronic health record system.

The system 100 can send automatic emails to any address based on the browser based applications such as alarms, smoke out of bounds, trends for various vital signs, etc.

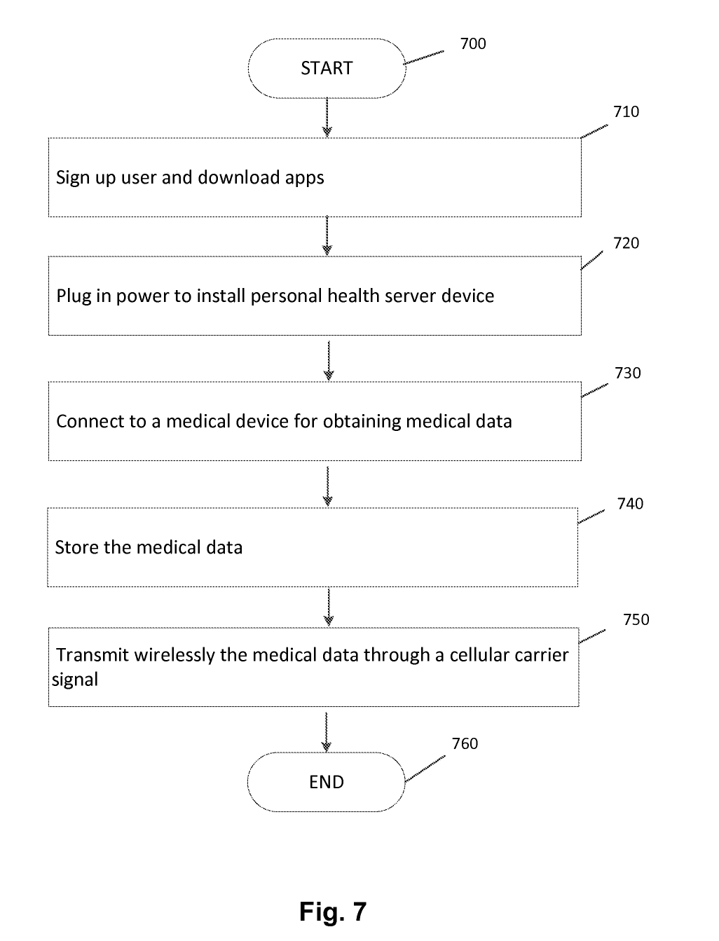

FIG. 7 illustrates a process of transmitting medical data through the cellular carrier signal 120 according to an embodiment of the invention. The process starts at step 700. At step 710, a doctor or somebody else signs up the user (e.g., the patient, person, etc.) and they download the applicable apps 645 onto the smartphone 225 or PC 227. Then, at step 720, the user or somebody else plugs in the power cord of the device 105. No more setup is required. The device 105 connects to one or more of the medical devices 110 for obtaining medical data at step 730. This connection can be wireless or wired. Next, at step 740, the device 105 stores the medical data. Then, at step 750, the device 105 wirelessly transmits the medical data through the cellular carrier signal 120 to a doctor, the user, a family member, or another person. The process may be repeated recursively a number of times and ends at step 760.

It is to be recognized that depending on the embodiment, certain acts or events of any of the methods described herein can be performed in a different sequence, may be added, merged, or left out altogether (for example, not all described acts or events are necessary for the practice of the method). Moreover, in certain embodiments, acts or events may be performed concurrently, for example, through multi-threaded processing, interrupt processing, or multiple processors, rather than sequentially.

In an embodiment of the invention, the medical devices 110 are sensors or comprise sensors such as, but not limited to motion detectors. A motion detector is placed in each of a plurality of rooms within a personal residence, nursing home, or hospital. For example, a first motion detector is placed in a bedroom, a second motion detector is placed in a bathroom, and a third motion detector is placed in a kitchen, and so on. In other words, a separate motion detector is placed in separate areas of interest including, but not limited to a bedroom, a living room, stairs, a balcony, a garden, a kitchen, and a toilet or bathroom. The motion detectors are used to determine when a person transitions, i.e., moves or relocates, from the view of one motion detector to another.

Transitions are recorded in a database. For example, the database stores statistics as to the frequency and timing of transitions between locations, e.g., from bedroom to bathroom. The statistics enable health providers to monitor irregular activity, i.e., departures from norm, of patients that may be a sign of a health problem. For example, is a person up at night? Are they going from the bedroom to the bathroom frequently? Are they waking up at the same time in the morning and going into the living room and the kitchen? Are they just hanging out in the living room watching TV? Are they leaving the house for a walk?

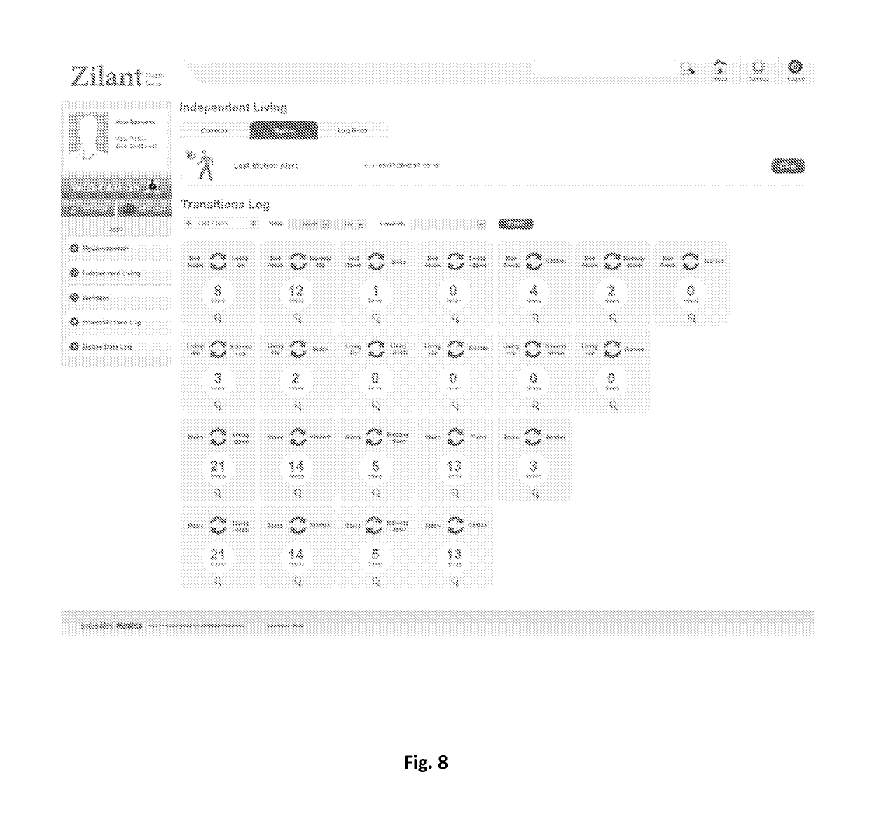

FIG. 8 illustrates a transitions log according to an embodiment of the invention. Here, the number of transitions between two areas of interest in a given period of time are displayed. For example, the patient transitioned from the area of stairs to or from the living room 21 times. The patient transitioned from the area of stair to or from the kitchen fourteen times. Statistical analysis can be used to determine health issues. For example, when the number of transitions between a first area and a second area over a given time deviates from a norm, say, in excess of a predetermined amount, then an alert is sent to a health provider or personal monitor, e.g., friend or relative. As an example, the norm for a patient transitioning from a bedroom to a bathroom is twenty one times per week—if the transitions for a given week total twenty eight or more, then the patient may have a serious health problem, e.g., bladder or prostate issue, that needs to be checked on.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

What is claimed is:

1. A method implemented entirely on a processor comprising the steps of:
receiving signals from a plurality of motion sensors, wherein the signals indicate movement of a living subject, each of the plurality of motion sensors located in a different physical area of interest,
determining a number of transitions of the living subject from a first physical area of interest to a second physical area of interest over a given period of time, and
recording the determined number of identified transitions of the living subject from the first physical area of interest to the second physical area of interest.

2. The method of claim 1, wherein the different physical area of interest is selected from the group consisting of: a bedroom, a living room, stairs, a balcony, a garden, a kitchen, a toilet or bathroom, and a combination thereof.

3. The method of claim 1, further comprising the step of displaying the determined number of identified transitions of the living subject from the first physical area of interest to the second physical area of interest.

4. The method of claim 1, further comprising determining a number of transitions of the living subject from a third physical area of interest to a fourth physical area of interest over the given period of time, and
recording the determined number of identified transitions.

5. The method of claim 1, further comprising the step of analyzing the determined number of identified transitions of the living subject from the first physical area of interest to the second physical area of interest against a predetermined norm, and calculating a deviation of the determined number of identified transitions of the living subject from the first physical area of interest to the second physical area of interest from the predetermined norm.

6. The method of claim 5, further comprising generating an alert when the deviation exceeds a predetermined threshold.
